(19) United States
(12) Patent Application Publication
(10) Pub. No.: US 2003/0034897 A1
(43) Pub. Date: Feb. 20, 2003

(54) Thermostat and remote control apparatus

(76) Inventors: Charles G. Shamoon, Raleigh, NC (US); Deborah H. Shamoon, Raleigh, NC (US)

Correspondence Address: Richard C. Litman, LITMAN LAW OFFICES, LTD., P.O. Box 15035, Arlington, VA, 22215, US

(21) Appl. No.: 09/931,985

(22) Filed: Aug. 20, 2001

(51) Int. Cl. G08C 19/00

(52) U.S. Cl. 340/825.72

(57) ABSTRACT

A thermostat and remote control apparatus, that is made up of a housing, an interface disposed in the housing, a plurality of icons on the interface, which correspond to a set of controls for items that can be controlled by the apparatus, a display screen, which indicates the current temperature setting, time and date, a recessed program and enter button that allows a user to enter temperature settings to a thermostat, a clear button for deleting any entered information, an electric cradle that is used to recharge the apparatus, a universal serial bus port (USB) that is used to connect a computerized device to the apparatus, an RS-232 port to standardize a transmission of serial data between any devices and the apparatus and a microcontroller for processing information and data. The apparatus specifically utilizes infrared and radio frequency technology for transmitting and receiving information from various items.

### BACKGROUND OF THE INVENTION

1. Field of the Invention

The present invention relates to a thermostat and remote control apparatus.

2. Description of the Related Art

Most modern families use several remote control devices to operate and utilize a wide variety of electronic equipment in their respective household. Use of a remote control is commonplace for operating televisions, stereos, garage door openers and video cassette recorders. Remote control systems are also used at the commercial level as well. A variety of different technologies can also be applied to a remote control.

The related art discloses the use of a remote control to control several pieces of equipment. U.S. Pat. No. 4,965,557 issued to Schepers et al., outlines the use of the interactive control of an entertainment electronics apparatus. The apparatus can be simplified so that an unpracticed user can easily make all of the necessary or desired adjustments wanted, even in the case of a large system.

U.S. Pat. No. 5,109,222 issued to Welty, describes certain new and useful improvements in remote control systems for controlling electronically operable equipment in occupiable structures, and more specifically to remote control equipment with an essentially unlimited command format such that the system is responsive to a large number of pieces of electronic equipment having different command formats and which system can generate encoded signals compatible with any such electrically operated equipment.

U.S. Pat. No. 5,544,036 issued to Brown, Jr. et al., describes the use of an energy management and home automation system which includes one or more controllers in each facility being managed and one or more energy consuming devices attached to each controller. Each controller responds to digital paging signals from a central command center which establish a schedule of events effecting the operation of each device and the controller schedules each device to be operated pursuant to the programmed schedule.

U.S. Pat. No. 5,545,857 issued to Lee et al., teaches a remote control method and apparatus for a remote controller having a touch panel as an image apparatus, performing a remote control operation of an image apparatus, such as a television, either by inputting a character onto the touch panel or by controlling a cursor according to the contact location of a finger or a pen contacting the touch panel.

U.S. Pat. No. 5,579,496 issued to Van Steenbrugge, teaches the use of a method and apparatus for processing control instructions received from at least 2 identifiable sources via a communication connection. The method can be used in apparatuses which are coupled together by a bus. The invention also relates to an apparatus provided with a control circuit adapted to perform the method.

U.S. Pat. No. 5,621,662 issued to Humphries et al., teaches a home automation system made up of a number of sub-systems for controlling various aspects of a house, such as a security system, an HVAC system, a lighting control system and an entertainment system. The network utilizes a host computer connected through a host interface to a plurality of nodes. The network is in a free form topology and employs asynchronous communication.

U.S. Pat. No. 5,818,428 issued to Eisenbrandt et al., teaches the use of a control system with a user configurable interface, particularly suitable for use in connection with appliances. Users can configure display screens at a point of sale location or at home with a personal computer. An user interface includes both the hardware and the software via which a user interacts with a control system and includes visual indicators, switches and display systems.

U.S. Pat. No. 5,924,486 issued to Ehlers et al., teaches the use of a residential or commercial environmental condition control system and, more specifically, to a system that controls internal environmental conditions to optimize comfort and minimize energy consumption cost, based on user defined parameters.

U.S. Pat. No. 6,005,490 issued to Higashihara, teaches the use of a bidirectional remote control apparatus which can exchange a control signal between a remote control transmitter and controlled equipment in two directions.

U.S. Pat. No. 6,081,750 issued to Hoffberg et al., teaches the use of an adaptive interface for a programmable system for predicting a desired user function, based on user history, as well as machine internal status and context. The apparatus receives an input from a user and other data. A predicted input is presented for confirmation by the user and the predictive mechanism is updated based on this feedback.

U.S. Pat. No. 6,216,956 B1 issued to Ehlers et al., teaches the use of an indoor environmental condition control and energy management system with a plurality of inputs. A user input receives user input parameters including a desired indoor environmental condition range for at least one energy unit price point. An indoor environmental condition input receives a sensed indoor environmental condition. An energy price input receives a schedule of projected energy unit prices per time periods.

Each of the described patents have a useful application regarding remote controls and remote control systems. None, however, can completely bypass the use of a personal computer and constantly update the readings from the components of a remote control system. No system also includes temperature setting controls with more common appliance and electronic device controls as well.

None of the above inventions and patents, taken either singularly or in combination, is seen to describe the instant invention as claimed. Thus a thermostat and remote control apparatus and method solving the aforementioned problems is desired.

### SUMMARY OF THE INVENTION

The invention is a thermostat and remote control apparatus that is made up of a housing, an interface disposed in the housing, a plurality of icons on the interface, which correspond to a set of controls for items that can be controlled by the apparatus, a display screen, which indicates the current temperature setting, time and date, a recessed program and enter button that allows a user to enter temperature settings to a thermostat, a clear button for deleting any entered information, an electric cradle that is used to recharge the apparatus, a universal serial bus port (USB) that is used to connect a computerized device to the apparatus, an RS-232 port to standardize a transmission of serial data between any devices and the apparatus and a microcontroller for processing information and data. The apparatus specifically utilizes infrared and radio frequency technology.

Accordingly, it is a principal object of the invention to provide a remote control that can make changes to a thermostat.

It is another object of the invention to provide a remote control that can be run independently of a personal computer.

It is a further object of the invention to provide a remote control that can constantly monitor and update information

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a thermostat and remote control apparatus according to the present invention.

FIG. 2 is a front perspective view of a remote control apparatus according to the present invention.

FIG. 3 is a perspective view of a remote control apparatus and charger according to the present invention.

FIG. 4 is a perspective view of a remote control apparatus and its components according to the present invention.

FIG. 5 is a flow diagram of a remote control apparatus and its entertainment center components according to the present invention.

FIG. 6 is a flow diagram of a remote control apparatus and its thermostat and X-10 components according to the present invention.

Similar reference characters denote corresponding features consistently throughout the attached drawings.

### DETAILED DESCRIPTION OF THE PREFERRED EMBODIMENT

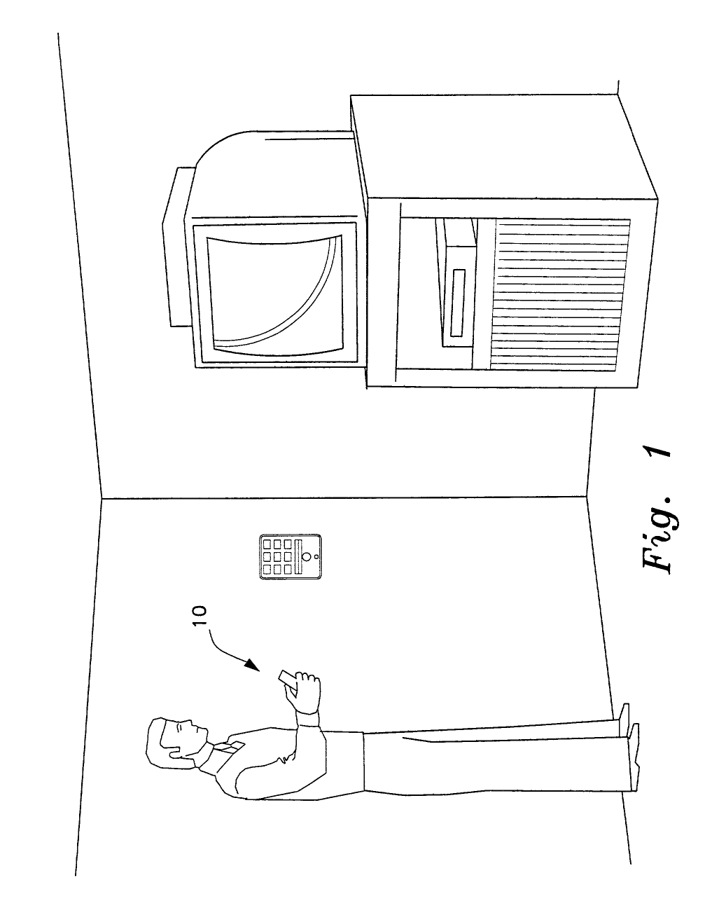

The present invention relates to a thermostat and remote control apparatus 10. The thermostat and remote control apparatus 10 consolidates all remote controls into a single remote control as well as combining the capability to control a user's thermostat. The thermostat and remote control apparatus 10 is illustrated in FIG. 1.

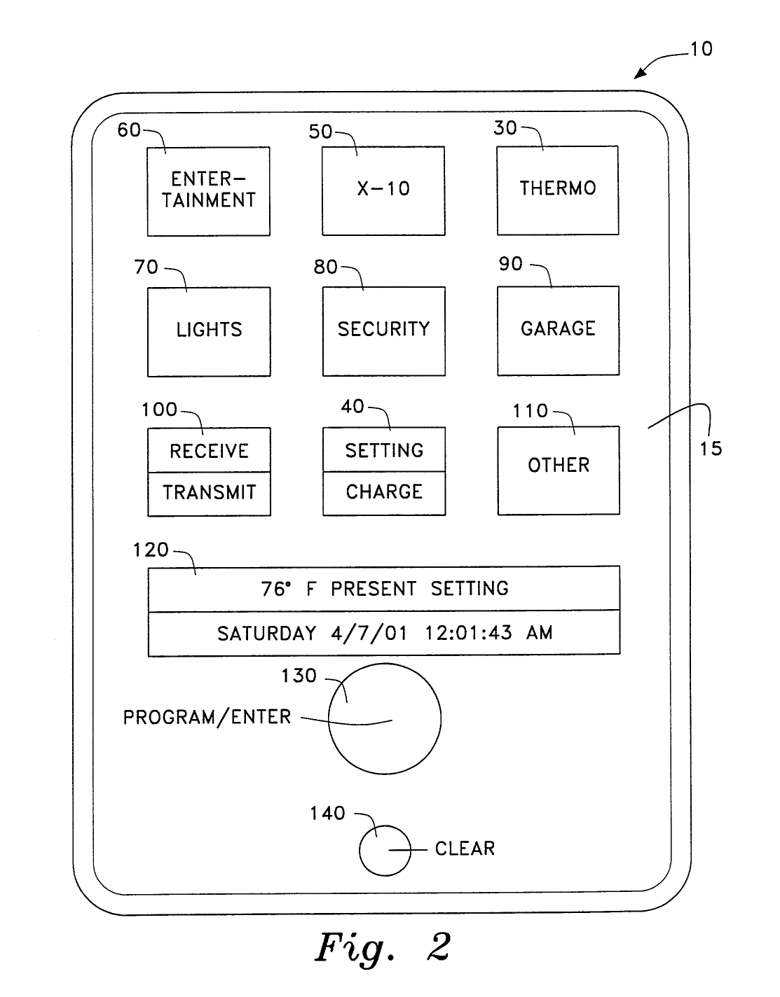

The thermostat and remote control apparatus 10 has a housing and interface 15 that is illustrated in FIG. 2. The housing and interface 15 displays a plurality of icons that can be chosen which correspond to a set of controls for each item that can be controlled by the thermostat and remote control apparatus 10. For example, an “Entertainment” icon 60 is shown and can be selected. Once selected, by depressing the “Entertainment” icon 60, the entire face of the thermostat and remote control apparatus 10 changes to a variety of control icons that pertain to the selected icon.

In the case of the selected “Entertainment” icon 60, the main menu would then display various components of the user's entertainment center, such as a CD player, a television, a record player and any other components of the user's entertainment center. Each component from the entertainment center has its own set of settings, which are displayed on the housing and interface 15 of the thermostat and remote control apparatus 10 once selected by the user. The thermostat facing is the same as the remote control apparatus 10, only without the entertainment icon 30.

These settings can also include a display touch screen as well as “Volume” settings, “Channel” settings and other settings. As shown in FIG. 2, other icons include X-10 system settings 50, a thermostat setting 60, light settings 70, a security system setting 80 and a garage setting 90. An icon for indicating when a signal is transmitted and/or received 100 is provided and will light up the appropriate icon half when being completed. An “Other” 110 icon can also be used for adding additional and lesser used components to the thermostat and remote control apparatus 10. The “Setting” icon 40, also has a lower half “Charge” icon, which can be illuminated to indicate that the apparatus 10 is being charged up.

A display screen 120 indicating the temperature setting, date and time, is always displayed for all settings. The thermostat and remote control apparatus 10 is also provided with a “Program/Enter” button 130 and a “Clear” button 140. The “Program/Enter” button 130 and the “Clear” button 140 are also recessed to prevent accidental depression.

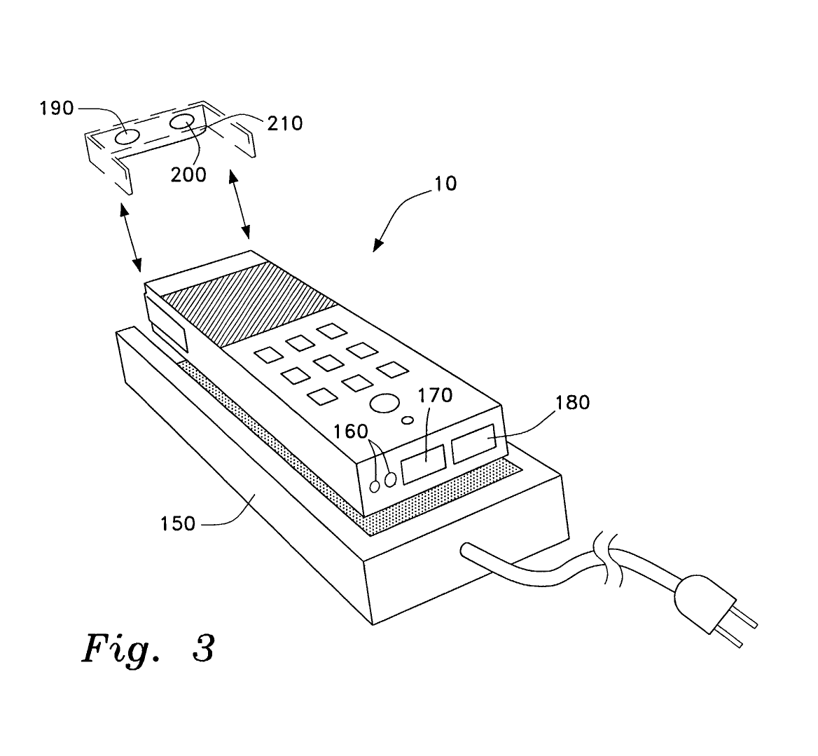

FIG. 3 illustrates a cradle 150 that is used to charge up the apparatus 10. The cradle 150 has two contact points 160 that are in contact with the apparatus 10 while the apparatus 10 is charging. There is also a universal serial bus (USB) port 170 that can be connected to another computer and a recommended standard (RS-232) port 180 is also used to standardize the transmission of serial data between devices. The cradle 150 can charge using a standard electrical outlet (not shown).

The cradle 150 allows a user to utilize the apparatus 10 while it is being charged. This can occur since the infrared transmitter 190 and receiver 200 is openly exposed through the open side of the cradle 150 and allows for infrared interactions. An antenna 210 is also openly exposed as well to allow for radio frequency (RF) reception and transmission.

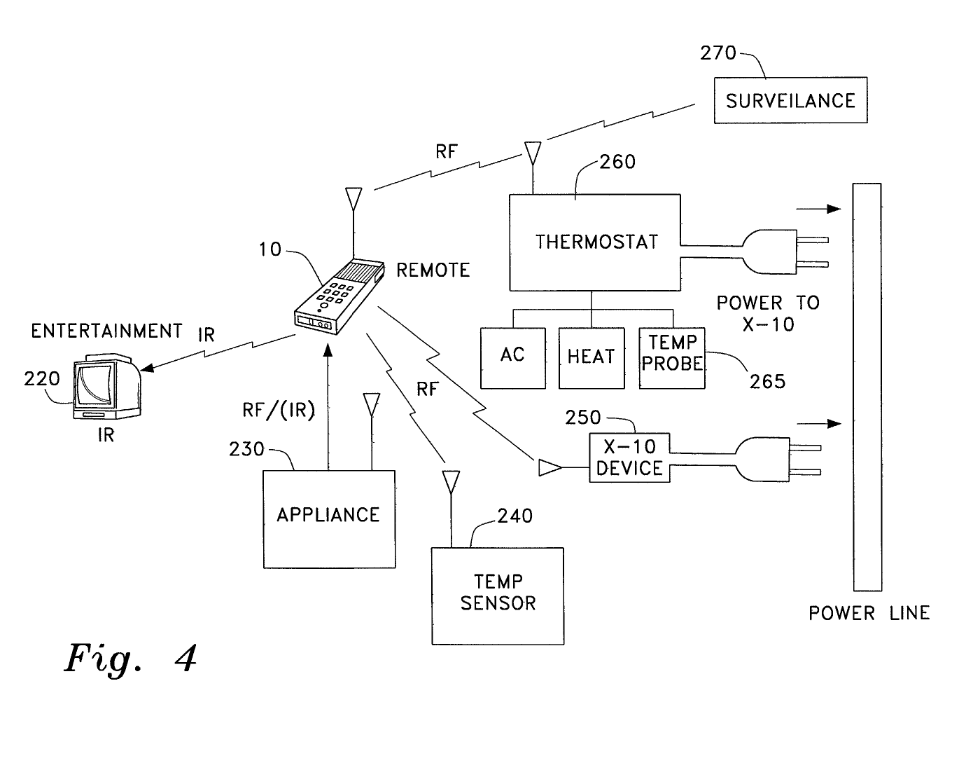

FIG. 4 depicts the thermostat and remote control apparatus 10 and its various components. There is a transmitting means for transmitting a signal to an entertainment center 220 and household appliances 230, which utilize infrared technology. The entertainment center 220 and household appliances 230 must be provided with an infrared signal transmitter (not shown) and receiver (not shown) to correspond and communicate with the infrared transmitter 190 and receiver 200 of the thermostat and remote control apparatus 10.

The thermostat and remote control apparatus 10 also utilizes radio frequency technology as well. A transmitting means for transmitting a signal to a temperature sensor 240, an X-10 device 250, a thermostat 260 and surveillance equipment 270, are provided, which utilize radio frequency technology (RF).

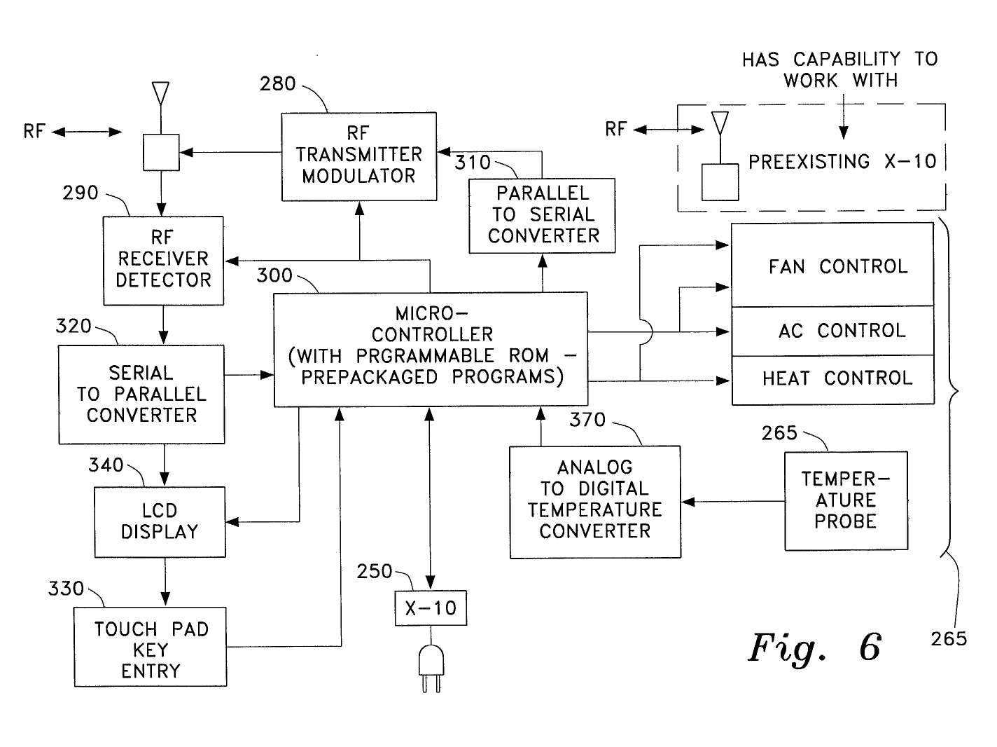

The temperature sensor 240, the appliance 230, X-10 device 250, thermostat 260 and surveillance equipment 270 must be provided with an RF transmitter and receiver (not shown) to correspond and communicate with the RF transmitter 280 (FIG. 6) and receiver 290 (FIG. 6) of the thermostat and remote control apparatus 10. The thermostat 260 and temperature probe 265 are the controlling devices for a user's heating and air conditioning equipment, which are typically powered with electrical power and natural gas power. A temperature sensor 240 may be used to sense temperature in a remote location.

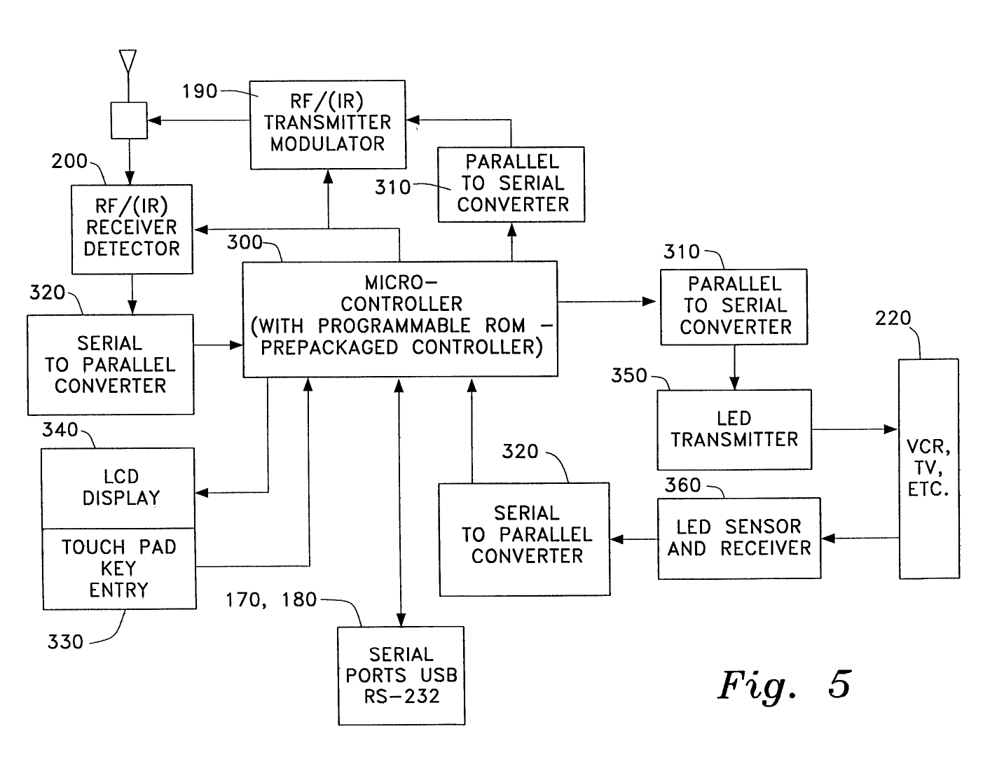

FIG. 5 depicts an overview of the infrared technology used by the thermostat and remote control apparatus 10. A powerful microcontroller 300 is at the heart of the use of the infrared technology. The microcontroller 300 is also provided with programmable read only memory (PROM) 305 as well as prepackaged software (not shown) that runs the hardware and other components of the thermostat and remote control apparatus 10. This software is known to those skilled in the related art.

The infrared receiver 290 receives an infrared signal and runs the signal to a serial to parallel convertor 320 before sending the signal to the microcontroller 300. The infrared transmitter 280 uses a parallel to serial converter 310 before sending information from the microcontroller 300. Information is input into the microcontroller 300 from a touchpad 330 and is displayed on a liquid crystal diode (LCD) display 340 of the interface 20.

Similarly, a microcontroller 300 sends a signal to a parallel to serial converter 310 to a light emitting diode (LED) transmitter 350, which sends a signal to the entertainment center 220. The entertainment center 220 then sends a signal back to the LED receiver 360, which send a signal to a serial to parallel converter 320, which then sends a signal to the microcontroller 300. The microcontroller 300 is also directly linked to a USB port 170 and a RS-232 port 180. The microcontroller 300 may also be reprogrammed via USB port 170 or RS 232 port 180.

The use of RF technology is similarly used and outlined in FIG. 6. An RF receiver 290 receives a RF signal and sends a signal to a serial to parallel converter 320, which is then sent to a microcontroller 300. The microcontroller 300 then sends a signal to the LCD display 340. A user then enters desired information from a touchpad 330, which is sent to the microcontroller 300, which is sent to a parallel to serial converter 310 and eventually to a RF transmitter 280.

A temperature probe 265 also sends a signal to an analog to digital temperature converter 370, which sends a signal to the microcontroller 300. The microcontroller 300 then sends a signal to the fan control, air conditioning control and heat control of the thermostat 260. An X-10 250 adapter is also in direct contact with the microcontroller 300, which can communicate and be powered by a standard wall outlet. The microcontroller 300 will lay dormant when not in use and can be reactivated by pressing the program/enter key 130.

The thermostat and remote control apparatus 10 does not need to utilize a personal computer because of the powerful microcontroller 300 incorporated with the apparatus 10. Two-way communication exists between the apparatus 10 and the thermostat 260. Date, time and thermostat settings are updated from the thermostat 260 to the thermostat and remote control apparatus 10 periodically.

The thermostat 260 has “Transmit” and “Receive” indicators that show the communication states of the thermostat and remote control apparatus 10. There is a built-in clock on the apparatus 10 that is synchronized to the thermostat 260. The apparatus 10 also has a “ProgramEnter” button 130 that allows a user to enter and activate setting on touchpad 330 display such as temperature settings to the thermostat 260.

It is to be understood that the present invention is not limited to the embodiment described above, but encompasses any and all embodiments within the scope of the following claims.

We claim:

1. A thermostat and remote control apparatus, comprising:
a housing;
an interface disposed in said housing;
a plurality of icons on the interface, which correspond to a set of controls for items that are controlled by the apparatus;
a display screen, which indicates the current temperature setting, time and date;
a recessed program and enter button that allows a user to enter temperature settings to a thermostat;
a clear button for deleting any entered information;
an electric cradle that is used to recharge the apparatus;
a universal serial bus port (USB) that is used to connect a computerized device to the apparatus;
an RS-232 port to standardize a transmission of serial data between any devices and the apparatus;
a microcontroller for processing information and data;
a serial to parallel converter and a parallel to serial converter; and
a transmitting means for transmitting a signal to and from an item that can be controlled by the apparatus.

2. The apparatus according to claim 1, further comprising an entertainment center, and wherein the item controlled by the apparatus is said entertainment center.

3. The apparatus according to claim 1, further comprising a thermostat, and wherein the item controlled by the apparatus is said thermostat.

4. The apparatus according to claim 1, further comprising household appliances, and wherein items controlled by the apparatus are said household appliances.

5. The apparatus according to claim 1, further comprising devices with an X-10 protocol, and wherein items controlled by the apparatus are said devices with an X-10 protocol.

6. The apparatus according to claim 1, further comprising a security system, and wherein the item controlled by the apparatus is said security system.

7. The apparatus according to claim 1, wherein said transmitting means for transmitting information to and from an item is an infrared transmitter and receiver.

8. The apparatus according to claim 1, wherein said transmitting means for transmitting information to and from an item is a radio frequency transmitter and receiver.
